(19) United States
(12) Patent Application Publication
(10) Pub. No.: US 2022/0410246 A1
(43) Pub. Date: Dec. 29, 2022

(54) FUSELAGE HEAT EXCHANGER FOR COOLING POWER SOURCE FOR UNMANNED AERIAL VEHICLES (UAVS)

(71) Applicant: UltraCell LLC, Livermore, CA (US)

(72) Inventors: Ru CHEN, Dublin, CA (US); Ian W. KAYE, Livermore, CA (US); John Ryan MURPHY, Tracy, CA (US)

(21) Appl. No.: 17/848,306

(22) Filed: Jun. 23, 2022

Related U.S. Application Data
(60) Provisional application No. 63/215,046, filed on Jun. 25, 2021.

(51) Int. Cl. B21D 53/04; F28F 21/08; F28D 21/00; H01M 8/04029

(52) U.S. Cl. CPC B21D 53/04; F28F 21/084; F28D 21/00; H01M 8/04029; F28D 2021/0021; F28F 2275/061

(57) ABSTRACT

A fuselage heat exchanger having channels for dissipating waste heat generated by fuel cells that power unmanned aerial vehicles (UAVs) or drones. A heat exchanger built into the fuselage can dissipate such waste heat. Coolant flowing through channels embedded within an aircraft fuselage panel dissipates heat to airflow around the outer surface of the fuselage.

### RELATED APPLICATIONS

This application claims the benefit of U.S. Provisional Application No. 63/215,046, filed on Jun. 25, 2021. The foregoing application is hereby incorporated by reference herein for all purposes.

### BACKGROUND OF THE INVENTION

The present disclosure generally relates to thermal management of fuel cells. More specifically, the disclosure relates to thermal management of fuel cell systems used in unmanned aerial vehicles (UAVs) or drones.

Fuel cells are electrochemical devices that can be used in a wide range of applications, including transportation, material handling, stationary, and portable power applications. Fuel cells have been used to power UAVs. Fuel cells use fuel and air to generate electricity by electrochemical reactions and release the products of the reactions as exhaust. For example, the products generated by methanol fuel cells are water and carbon dioxide. In addition to electricity, some energy in the fuel is released as heat. The waste heat from fuel cells must be effectively dissipated during operation of the fuel cell system.

Traditional radiator cooling methods add significant and weight to the UAV. Some UAV fuel cells are air cooled. Therefore, it would be desirable to be able to provide a cooling system without ducting for aircraft that allow the aircraft to be lightweight and compact.

### SUMMARY OF THE INVENTION

In accordance with an embodiment, a fuselage heat exchanger panel is provided. The fuselage heat exchanger panel a joined panel having flow channels embedded therein for providing a flow path for a fluid coolant.

In accordance with another embodiment, a method is provided for forming a fuselage heat exchanger panel. A first sheet of metal is hydroformed to form a plurality of flow channels therein. A second sheet of metal is joined to the first sheet of metal to form a joined panel having a plurality of flow channels embedded therein after hydroforming.

In accordance with yet another embodiment, a fuselage heat exchanger panel is provided. The fuselage heat exchanger panel includes a first sheet of metal and a second sheet of metal. The first sheet of metal is hydroformed with a plurality of flow channels therein. The second sheet of metal is a flat panel joined with the first sheet of metal to form a joined panel having flow channels embedded therein.

### BRIEF DESCRIPTION OF THE DRAWINGS

The invention, together with further objects and advantages thereof, may best be understood by reference to the following description taken in conjunction with the accompanying drawings in which:

FIG. 1A shows an example of a glider aircraft

FIG. 1B shows an example of a fighter jet.

FIG. 2 is a perspective view of a thin sheet of metal being pressed onto a die in a hydroforming process in accordance with an embodiment.

FIG. 3 is a top perspective view of a portion of a hydroformed sheet of metal in accordance with an embodiment.

FIG. 4 is a top perspective view of a hydroformed sheet of metal with support tooling in accordance with an embodiment.

FIG. 5 is a perspective view of a joined panel after rolling in accordance with an embodiment.

FIG. 6 is a perspective view of an aircraft fuselage in accordance with an embodiment.

FIG. 7 is a flow chart of a method of forming a fuselage panel in accordance with an embodiment.

### DETAILED DESCRIPTION OF EMBODIMENTS

The present invention relates generally to thermal management of fuel cell systems. Fuel cell systems can be used to provide power to UAVs. As noted above, in order to minimize the amount of drag on the aircraft, directed airflow using additional ducting should be avoided. Embodiments of fuel cell thermal management systems described herein are designed to be lightweight with minimal drag on an aircraft. The fuel cell is liquid cooled. The cooling loop consists of a coolant reservoir, a liquid pump, a cooling plate, and a fuselage heat exchanger. A cooling plate is a thermally conductive metal plate with a flow field. At least one cooling plate can be attached to or inserted inside the fuel cell. The fuselage heat exchanger is a section of the fuselage with embedded flow channels for the coolant. The liquid pump delivers the coolant from the reservoir to the cooling plate(s) where the coolant absorbs the waste heat from the fuel cell. The hot coolant flows to the fuselage heat exchanger and dissipates heat to the air that flows around the outer surface of the fuselage. The coolant is then circulated back to the reservoir. Since the heat exchanger is a section of the fuselage, it does not introduce additional drag. The fuselage heat exchanger allows for the shape of the aircraft to be as aerodynamic as possible.

The fuel cells used in the systems described herein are fueled by hydrogen-rich gases produced by reforming of gaseous and liquid fuels such as liquefied petroleum gas, methanol, gasoline, kerosene, and diesel. It will be understood that, in other embodiments, a fuel cell system can be fueled by other fuels, such as hydrogen. According to embodiments described herein, the fuel cells can be polymer electrolyte membrane or proton exchange membrane (PEM) fuel cells having a membrane electrode assembly (MEA). In a PEM fuel cell fueled by hydrogen, the membrane allows protons to transfer from an anode to a cathode with catalysts on both electrodes to assist in chemical reactions. Hydrogen is provided to the anode while oxygen is provided to the cathode. The hydrogen breaks down at the anode into electrons and protons, and the electrons pass through an external electrical circuit connected to the fuel cell to provide electrical power while the protons pass through the membrane to the cathode. The electrons and protons combine with oxygen at the cathode to produce water vapor.

Bipolar plates are positioned between individual fuel cells to separate them and provide electrical connection between the cells. The bipolar plates also provide physical structure and allow the stacking of individual fuel cells into fuel cell stacks to provide higher voltages. In some embodiments, the fuel cell system is fueled by hydrogen-rich gases produced by reforming methanol, natural gas, or liquefied petroleum gas, etc. In other embodiments, the fuel cell system can be fueled by other fuels, such as hydrogen. It will be understood that any other types of fuel cells can be used in a fuel cell system, including solid acid fuel cells, solid oxide fuel cells, phosphoric acid fuel cells, molten carbonate fuel cells, and alkaline fuel cells.

Heat is generated when a fuel cell produces electricity. Thus, to maintain desired fuel cell operating temperatures, excess waste heat must be removed. The thermal management of a fuel cell can be conducted by a variety of methods, including air cooling or liquid cooling, depending on the power outputs and applications.

Drag is the force that resists movement of an aircraft through the air. There are two basic types of drag: parasitic drag and induced drag. Induced drag is engineered into the design of the airfoils of an aircraft, which translates airspeed into lift. An aircraft using induced drag, such as a glider, is engineered to remain in the air for long periods of time. Induced drag is implemented to generate lift, but this increase in drag also limits velocity. On the other hand, an aircraft such as a fighter jet is optimized with little induced drag in order to achieve higher velocities. Thus, a fighter jet achieves higher speeds than a glider.

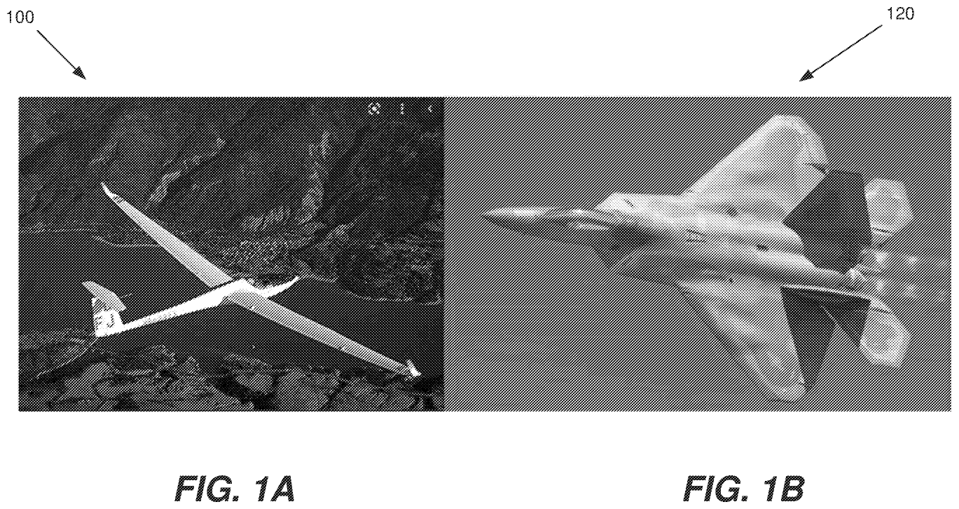

FIGS. 1A and 1B show the differences in airfoil design for a glider 100 (FIG. 1A) and a fighter jet 120 (FIG. 1B). The glider has more induced drag engineered into the wing design for more lift at lower speeds than the fighter jet. While induced drag is a pivotal design feature of an aircraft's wings, parasitic drag is not. Parasitic drag offers no advantages to the flight of an aircraft, and should therefore be minimized wherever possible.

Using a conventional radiator for cooling is not ideal for minimizing the amount of parasitic drag on an aircraft. Ducted airflow sent to a radiator creates high levels of parasitic drag, which reduces the fuel efficiency of an aircraft. Embodiments described herein include a radiator that is integrated into the fuselage of the aircraft to minimize the parasitic drag. Forced convective cooling is required for a fuel cell stack to operate inside of an aircraft. A section of fuselage panel containing flow channels for a circulating coolant can be fabricated into the shape of the aircraft itself. Thus, engineering the cooling solution into the fuselage skin reduces parasitic drag, making fuel cell drones more efficient.

The equation for aerodynamic drag D is provided in Equation (1):

D=Cd(ρV²/2)A (1)

where Cd is the drag coefficient, p is density of air, V is velocity, and A is reference area. Cd contains all the complex dependencies (due to the multiple sources of drag) and is typically determined experimentally (typically, in a wind tunnel). It will be understood that the choice of the reference area A affects the drag coefficient Cd. As shown by Equation (1), aerodynamic drag is proportional to the square of velocity V. Thus, the drag felt on an aircraft increases exponentially with velocity. Reducing drag is therefore extremely important for aircraft to achieve high velocities.

The lack of a dedicated airflow duct to a conventional radiator offers several advantages for flight capability. Specifically, the reduction in drag offers the ability for the aircraft to travel at a higher velocity, climb at a higher rate, and increase overall range. As shown by the equation above, the amount of drag on an aircraft is largely dictated by the velocity with which an aircraft is traveling. Increased drag incurred by the design of an aircraft impedes the ability of the aircraft to increase and maintain velocity. Therefore, a clear benefit of replacing a conventional radiator with a fuselage having embedded flow channels is increased speed and range.

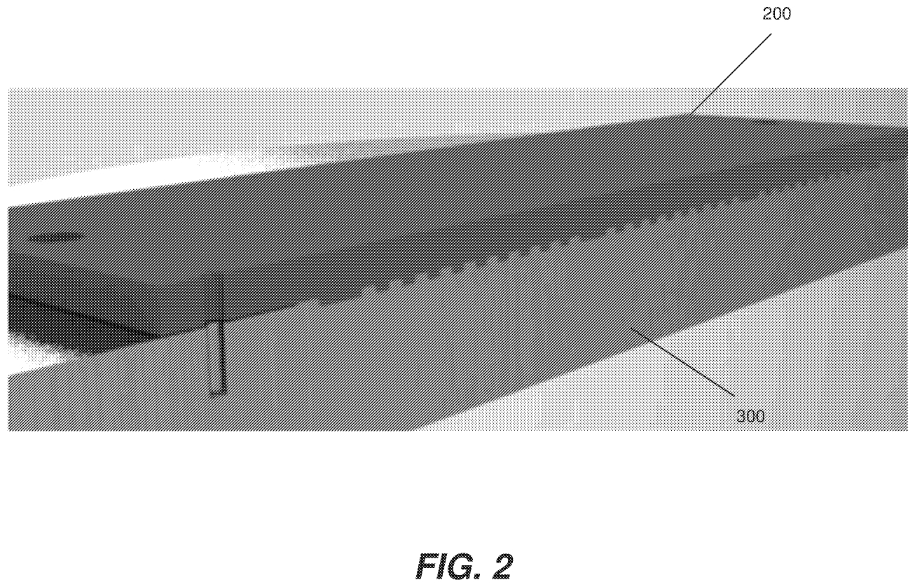

According to an embodiment, a fuselage panel of an aircraft is formed with flow channels. The channels provide a flow path for cooling fluid. In some embodiments, the fuselage panel is made using thin sheets of soft metal such as aluminum. Aluminum is an ideal material to use for a fuselage radiator given its low weight, relative strength, and high thermal conductivity. In a particular embodiment, the sheet of aluminum has a thickness of about 0.5 mm. A sheet of metal 200 can be hydroformed to create cooling channels 210 to form a desired coolant flow path in a fuselage panel, as shown in FIG. 2.

Hydroforming is a cost-effective type of die molding process that uses highly pressurized hydraulic fluid to press metal into a die at room temperature. In sheet hydroforming, a sheet of metal is pressed against a die by high pressure water on one side of the sheet to form the sheet into the desired shape. In a particular embodiment, a thin sheet of aluminum is hydroformed to form at least a portion of the fuselage panel. This fabrication method is advantageous because aluminum is not only lightweight but also has high thermal conductivity. Also, as noted above, hydroforming is a relatively inexpensive manufacturing process. Other fabrication methods of flow channels include embossing, stamping, machining, photochemical etching, and 3-D printing etc.

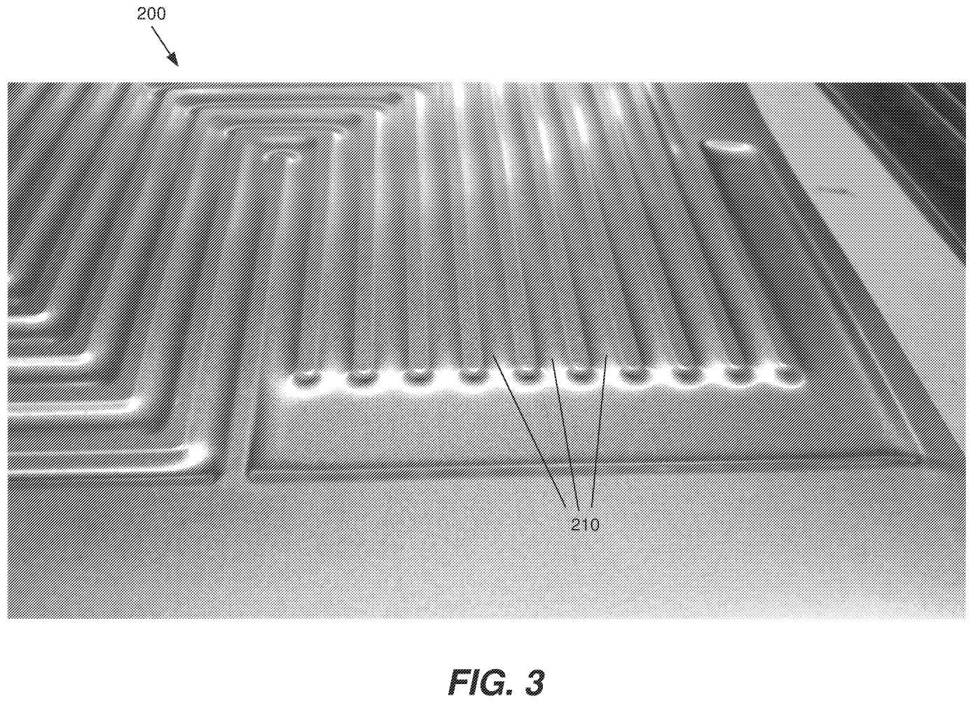

FIG. 2 illustrates a step in the hydroforming manufacturing process to form coolant channels in a thin sheet of metal 200, in accordance with an embodiment. As shown in FIG. 2, a thin metal sheet 200 is pressed against a die 300 to form coolant channels. FIG. 3 shows the thin sheet of metal 200 after the coolant channels 210 are formed. As shown in FIG. 3, the sheet of metal 200 has hydroformed flow channels 210. According to an embodiment, the fuselage panel having the flow channels 210 is formed from a piece of sheet aluminum. The hydroformed flow channels 210 are designed to provide coolant flow across the fuselage panel. The dimensions of channels depend on the amount of waste heat to be removed, the state of coolant, and pressure drop requirement, etc. The typical channels are about 3 mm deep and 6 mm wide.

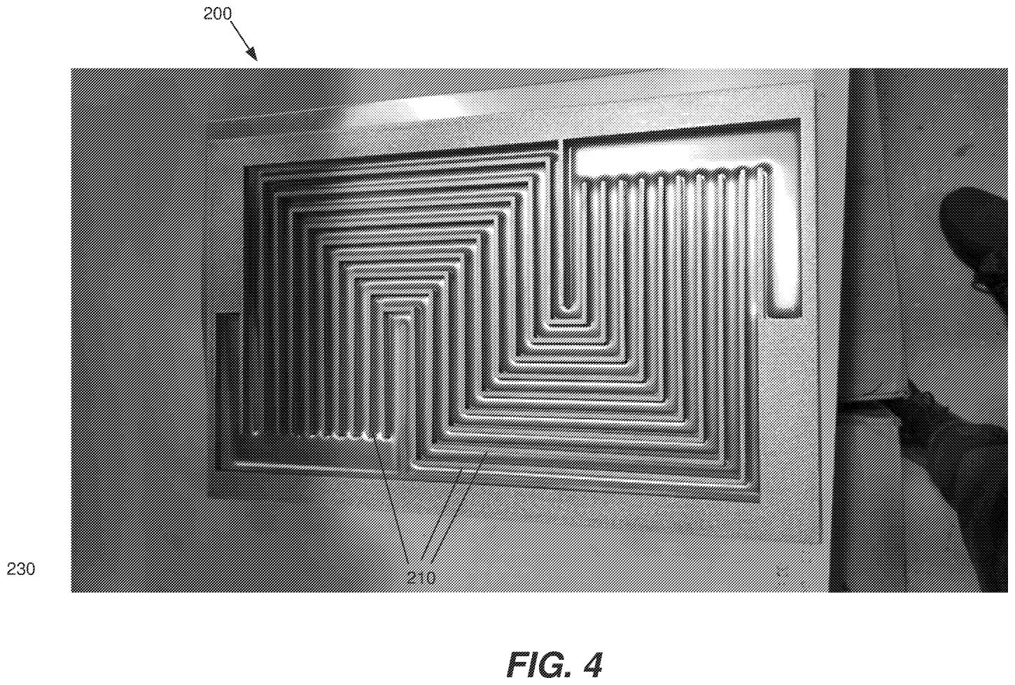

The hydroformed sheet metal 200 is then joined with a flat panel, either by brazing, welding, or diffusion bonding to form a joined panel 250 having flow channels embedded within the joined panel 250. The flat panel is preferably formed of the same metal as the hydroformed sheet 200. For example, it the hydroformed sheet 200 is aluminum, the flat panel is also aluminum such that both sheets of the joined panel 250 are aluminum. It will be noted that, for brazing, support tooling should be used to apply pressure to the braze joints and prevent the channels from being crushed, as shown in FIG. 4.

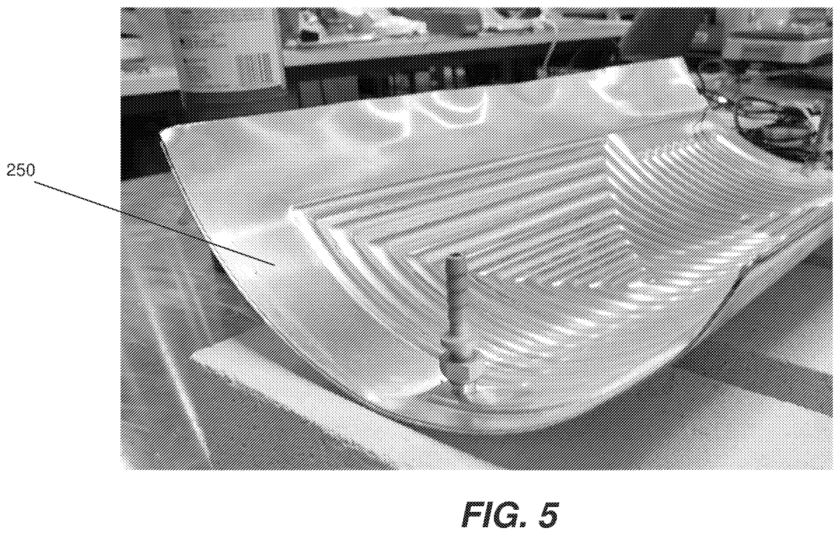

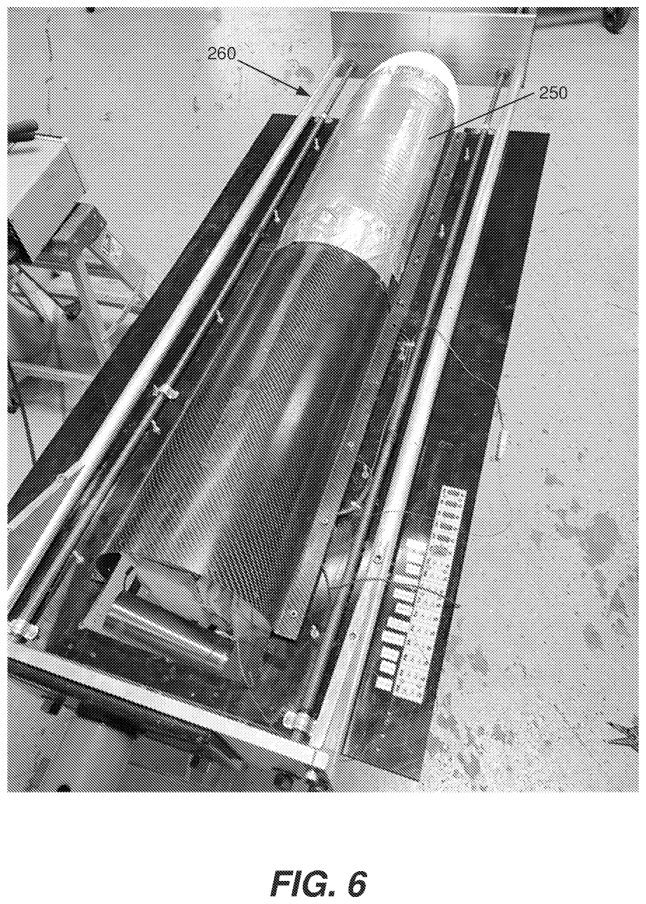

After the hydroformed sheet metal 200 is joined with a flat panel, the joined panel 250 is then bent to the desired shape or diameter using a roll bending machine, as shown in FIG. 5. The rolled panel can then be fitted and attached to and form a portion of the aircraft fuselage, as shown in the prototype in FIG. 6.

A mixture of ethylene glycol and water, for example, can be used as a heat transfer fluid flowing in the channels 210. Liquid coolants flowing in the channels 210 can help to remove excess heat from the fuel cell stacks and dissipate the heat to ambient air. In some embodiments, the fuel cell stacks can operate at temperatures up to 240° C. and the coolant temperature can be greater than 150° C.

Two-phase cooling can also be used to remove heat from the fuel cell stacks. In the cooling plate(s) that contact with the fuel cell, a portion of the coolant is transformed into vapor upon heating, resulting in a vapor/liquid mixture. Compared to single-phase liquid cooling, two-phase cooling increases heat dissipation for a given amount of fluid because the latent heat of vaporization can be orders of magnitude larger than the specific heat of the liquid. The two-phase cooling reduces coolant flow rate and thus coolant pump power consumption. In addition, two-phase cooling increases heat transfer coefficients and improves temperature uniformity.

Typically, cooling channels are integrated into traditional fuel cell stacks with a cooling plate inserted at regular intervals in the stacks. Both internal cooling and edge cooling can be used in UAV fuel cells. However, compared to internal stack cooling, edge cooling has several benefits. It eliminates issues with sealing the stack and improves reliability. Because the cooling plate is electrically isolated from the fuel cell stack, electrical conductivity of the coolant is not an issue. Therefore, there are more options for coolant selection, as there is no need to have coolant treatment in the cooling loop to reduce electrical conductivity. The coolant can be organic aqueous solutions, such as ethylene glycol/water and propylene glycol/water, or inorganic aqueous solutions, such as potassium formate/water. The operational temperatures of these fluids are in the range of about −50° C. to 220° C.

As will be appreciated by the skilled artisan, the embedded flow channels 210 provide large surface areas. The high internal surface area of the flow channels 210 in the fuselage panel 250 facilitates heat transfer from the coolant flowing within the fuselage panel to the airflow around the fuselage.

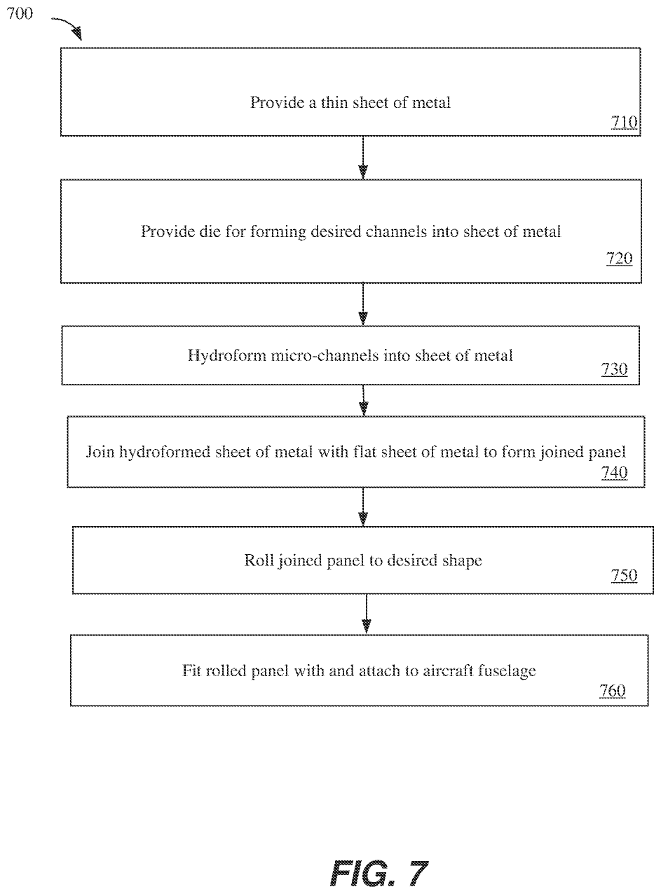

FIG. 7 is a flow chart of a method 700 of forming a fuselage panel having embedded channels in accordance with an embodiment. In Step 710, a thin sheet of metal is provided. In a particular embodiment, the thin sheet of metal is a sheet of aluminum having a thickness in a range of about 0.5 mm. In Step 720, a die is provided for forming flow channels 210 to provide the desired coolant flow path into the sheet of metal 200. The sheet of metal 200 is then hydroformed to form the flow channels in Step 730. The method 700 further includes Step 740 in which the hydroformed sheet metal 200 is joined with a flat panel, either by brazing, welding, or diffusion bonding, to form a joined panel 250 having flow channels embedded within the joined panel 250. In Step 750, the joined panel 250 is then rolled to the desired shape or diameter to fit with the rest of the fuselage in Step 760. The coolant can then be provided to flow through the embedded flow channels 210 to dissipate heat generated by the power source (e.g., fuel cell) of the aircraft.

In view of the foregoing, it should be apparent that the present embodiments are illustrative and not restrictive, and the invention is not limited to the details given herein but may be modified within the scope and equivalents of the appended claims.

What is claimed is:

1. A fuselage heat exchanger panel, comprising a joined panel having flow channels embedded therein for providing a flow path for a fluid coolant.

2. The fuselage heat exchanger panel, wherein the joined panel comprises:
a first sheet of metal, wherein the first sheet is formed with a plurality of flow channels therein; and
a second sheet of metal, wherein the second sheet is a flat panel joined with the first sheet of metal to form the joined panel having flow channels embedded therein.

3. The fuselage heat exchanger panel as recited in claim 2, further comprising fluid coolant in the embedded flow channels between the first sheet and the second sheet.

4. The fuselage heat exchanger panel as recited in claim 3, wherein the fluid coolant provides liquid or two-phase cooling as it flows within the embedded flow channels.

5. The fuselage heat exchanger panel as recited in claim 2, wherein the first sheet and the second sheet are joined by brazing, welding, or diffusion bonding.

6. The fuselage heat exchanger panel as recited in claim 2, wherein the flow channels are formed in the first sheet by hydroforming.

7. The fuselage heat exchanger panel as recited in claim 2, wherein the first sheet and the second sheet are aluminum.

8. A method of forming a fuselage heat exchanger panel, the method comprising:
hydroforming a first sheet of metal to form a plurality of flow channels therein; and
joining a second sheet of metal to the first sheet of metal to form a joined panel having a plurality of flow channels embedded therein after hydroforming.

9. The method as recited in claim 8, further comprising rolling the joined panel into a desired shape.

10. The method as recited in claim 9, further comprising attaching the joined panel to other portions of an aircraft fuselage after rolling the joined panel into the desired shape.

11. The method as recited in claim 8, wherein the first and second sheets of metal are aluminum.

12. The method as recited in claim 8, wherein second sheet is joined to the first sheet by welding, brazing, or diffusion bonding.

13. The method as recited in claim 8, further comprising providing fluid coolant to flow through the flow channels.

14. The method as recited in claim 13, wherein the fluid coolant provides liquid or two-phase cooling as it flows through the flow channels.

15. A fuselage heat exchanger panel, comprising:
a first sheet of metal, wherein the first sheet hydroformed with a plurality of flow channels therein; and
a second sheet of metal, wherein the second sheet is a flat panel joined with the first sheet of metal to form a joined panel having flow channels embedded therein.

16. The fuselage heat exchanger panel as recited in claim 15, further comprising fluid coolant in the embedded flow channels between the first sheet and the second sheet.

17. The fuselage heat exchanger panel as recited in claim 15, wherein the first and second sheets of metal are aluminum.

18. The fuselage heat exchanger panel as recited in claim 15, wherein the fluid coolant provides liquid or two-phase cooling as it flows within the embedded flow channels.

19. The fuselage heat exchanger panel as recited in claim 15, wherein the fluid coolant is a mixture of ethylene glycol and water.

20. The fuselage heat exchanger panel as recited in claim 15, wherein the fluid coolant is a mixture of propylene glycol and water.
